(19) United States
(12) Patent Application Publication
(10) Pub. No.: US 2016/0273392 A1
(43) Pub. Date: Sep. 22, 2016

(54) COMBINED CYCLE COMBUSTION ENGINE PROCESS AND COMBINED CYCLE COMBUSTION ENGINE

(71) Applicant: Massao Sakai, Sao Paulo (BR)

(72) Inventor: Massao Sakai, Sao Paulo (BR)

(21) Appl. No.: 15/035,215

(22) PCT Filed: Oct. 29, 2014
(86) PCT No.: PCT/BR2014/000393

§ 371 Date: May 6, 2016

(30) Foreign Application Priority Data
Nov. 12, 2013 (BR) 10 2013 029092-0

(51) Int. Cl. F01K 23/06; F02B 47/02; F02G 5/04

(52) U.S. Cl. CPC F01K 23/065; F02G 5/04; F02B 47/02

(57) ABSTRACT

The invention describes an Otto cycle or Diesel cycle internal combustion engine assembled with an energy and water recovery systems to Rankine cycle. In the first innovation, the high pressure steam, preferably above critical pressure, is injected in combustion chamber (20) in the end of compression (C) stroke reducing the combustion temperature and increasing internal pressure in the cylinder.

### FIELD OF APPLICATION

The present invention is related to an internal combustion engine, in which is applied the combined cycle concept used in thermoelectric power plant, combining the Otto or Diesel cycle with Rankine cycle, aiming the improvement of thermal yield e, consequently, the reduction of fuel consumption. Moreover, the invention allows to improve the quality of exhaustion gases released to the atmosphere reducing the concentration of Nox and particulated material.

### BACKGROUND

Combustion engines work with the burning of fuel, that are explosive chemical substances. This explosion happens inside a combustion chamber (20) especially designed to transform the energy released by explosion in mechanical movement of piston.

From 1980's, it has been used the concept of combined cycle in thermoelectric power plants and, according to it, the fossil fuel has been burned in gas turbine with around 30% efficiency, and the thermal loss around 70%, using in steam generation to drive steam turbine. The thermoelectric power plant based only in Rankine cycle has an yield around 35% and those using combined cycle concept, reach thermal yield up to 60%.

### STATE OF ART

In combustion engines, due to even more restrictive requirements related to CO, NOx and SOX emissions, it has been dealt in three aspects: fuel quality, catalyst and, mainly, reduction of combustion temperature. The reduction of combustion temperature is obtained with excess of combustion air (which causes efficiency losses) or with the recirculation of combustion gases (which causes volumetric efficiency losses).

The use of Otto/Diesel's cycles and Rankine's steam cycle combined, nowadays, is made by a residual heat recovery system (Waste Heat Recovery or WHR), rejected by flue gases to generate steam, which is used as driving fluid of a turbine. This conception is only viable in large-scale facilities due to the need of a repository water treatment plant to comply with the turbine steam requirements.

The patent EP0076885 proposed the injection of steam in a four stroke engine, converting it in a six stroke engine, four strokes in Otto or Diesel cycles, intercalated by two strokes of steam engine: steam injection and exhaustion. This conpection has the disadvantage of require significative modifications in combustion engine project, with characteristics in valves and controls that differs of convention an engine, besides the collector system for discharge steam and its recovery to replace the process water.

The Brazilian application BR 10 2012 013088-reports a combined cycle engine for internal combustion engine with Otto and Diesel cycle, where the high pressure steam is injected in the cylinders in order to gain mechanical power and the medium pressure steam is injected to reduce the compression temperature. The injection of low pressure steam increases the engine compression power, but it is not effective in temperature reduction compared with the injection of condensed steam proposed by this current patent application.

### DESCRIPTION OF DRAWINGS

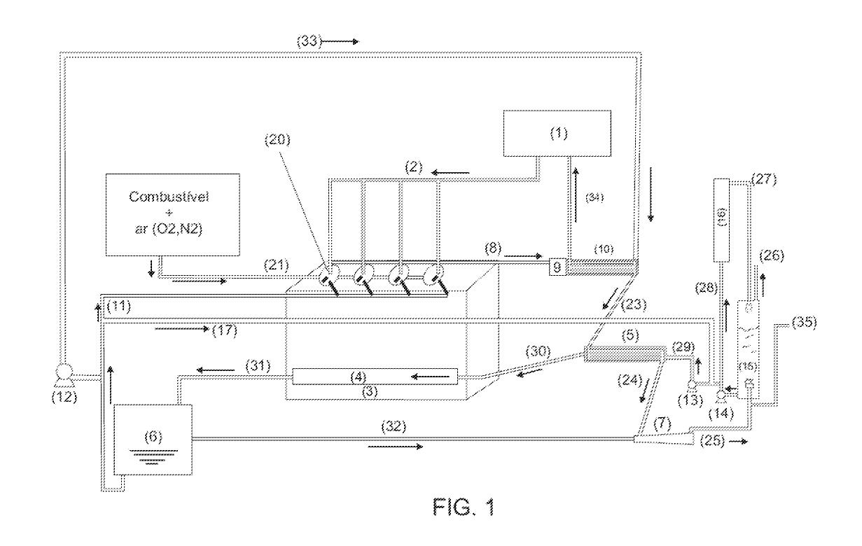

The FIG. 1 shows a complete flowchart of combined cycle engine process where it is indicated:

(1) high pressure drum;

(2) high pressure steam flux to the cylinders in the engine block (3);

(3) engine block;

(4) engine cooling system;

(5) pre-heater of low pressure condensate;

(6) low pressure drum;

(7) ejector for discharge of gases in the cylinders;

(8) discharge manifold;

(9) catalyst;

(10) Heat Recovery Steam Generator (HRSG);

(11) purge flux of low pressure drum;

(12) feed pump;

(13) condensate pump;

(14) circulation pump;

(15) condenser;

(16) radiator; and

(17) condensate recirculation flux to level control in low pressure drum;

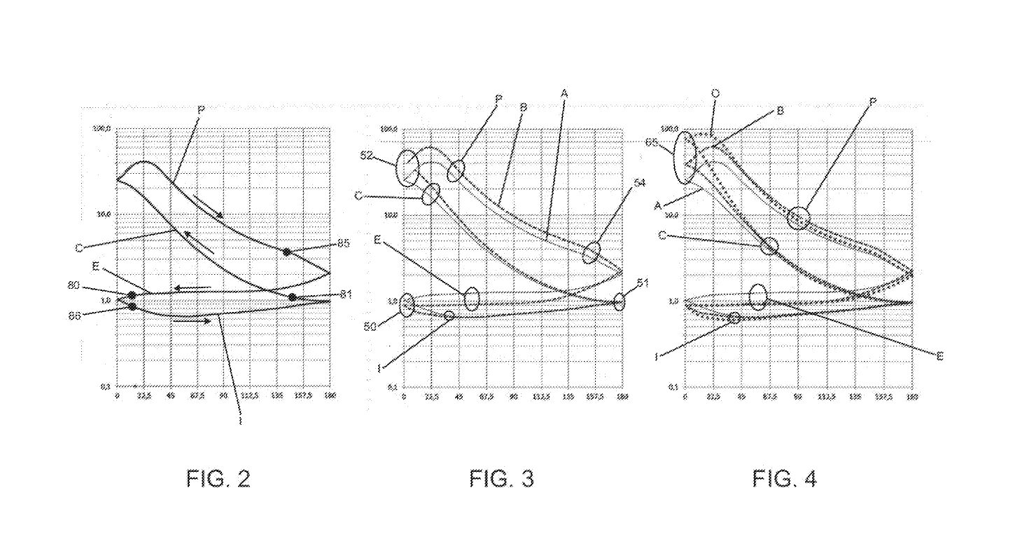

In FIGS. 2 to 7, the simulation results are shown, and it was adopted the following denomination in a four strokes combustion engine: intake (I), compression (C), power (P) and exhaustion (E).

The FIGS. 2, 3 and 4 represent the curve, in logarithmic scale, of absolute pressure (bar abs) inside the cylinders in function of crankshaft angle for each of the four strokes.

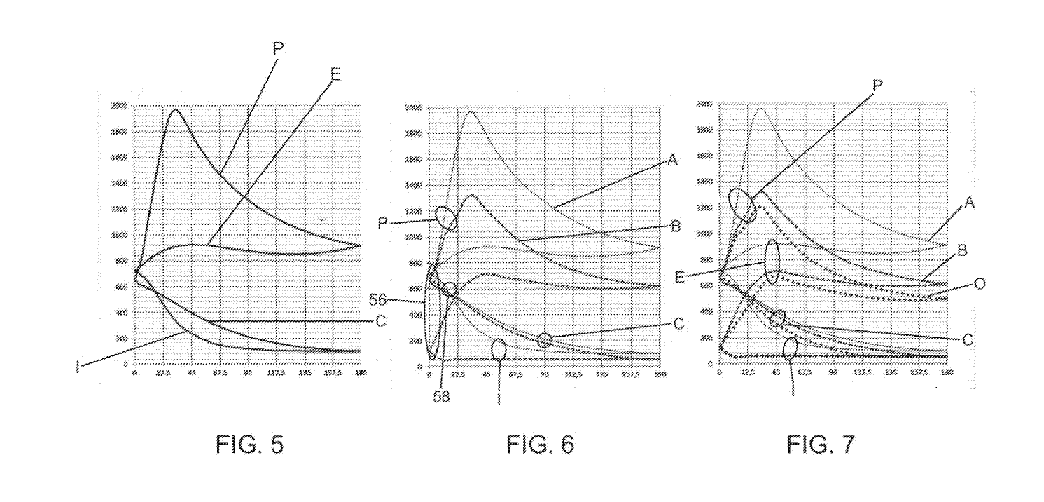

The FIGS. 5, 6 and 7 represent the curve of temperature (° C.) inside the cylinders in function of crankshaft angle for each of the four strokes.

### DESCRIPTION OF INVENTION

This invention is based on recovered thermal energy, that is rejected by a conventional internal combustion engine either by combustion gases exhaustion or by cooling system, using the combination of five technics that are innovative when compared with the state of art:

a) innovation 1: high pressure steam cycle, which steam is injected in the engine in order to reduce the temperature in power (P) stroke, but increases the internal pressure in the cylinders, increasing the piston work yield inside combustion chamber (20). The reduction of temperature reduces the NOx formation;

b) innovation 2: the injection of purged condensate from the low pressure drum (6) inside the combustion chamber (20) in the end of exhaustion (E) stroke. This injection allows a better expelling of combustion gas in the end of exhaustion (E) and controls the internal temperature of cylinders in compression (C), enabling a higher compression rate and higher piston work yield;

c) innovation 3: the use of ejector (7) in exhaustion gas circuit reduces the discharge pressure using the low pressure saturated steam (32) as driving steam, that helps the removal of exhaustion gases form combustion chamber (20) and reduces the piston work used for exhaustion of combustion gases;

d) innovation 4: the condenser (15) works as a recoverer of water in the system and as a gas filter or a gas washer, since the gases are bubbled on the bottom of the condenser (15), flowing through the condensate column, where the particulated material, which would be released in the environment, are retained.

e) innovation 5: the heat in the catalyst (9), generated by oxidation of hydrocarbon remained from incomplete combustion in the engine, is used to generate high pressure steam (10).

The FIG. 1 shows a possible compete assembly of combined cycle engine system.

In the combined cycle engine process, the air-fuel mixture (21) is fed in combustion chamber (20), with the simultaneous injection of purge condensate (11) in the low pressure drum (6), in the end of exhaustion (E) stroke in Otto or Diesel Cyce, innovation 2.

After that, in the enf of compression (C) stroke, the high pressure steam (2) in the high pressure tank (1) is injected in combustion chamber (20), innovation 1.

Thus, in the power (P) stroke, there are inside the combustion chamber (20): the air and the fuel that will be converted in combustion gases, part of injected purge condensate (11) from the low pressure drum (6) that is flashed and the high pressure steam (2) composing the exhaustion gases flux from combined cycle engine.

In the exhaustion (e), the exhaustion gases are discharged in the discharge manifold (8) and flows to the catalyst (9), where it absorbs the heat generated in this equipment before reach the Heat Recovery Steam Generator—HRSG (10), innovation 4.

In Heat Recovery Steam Generator—HRSG (10), happens the heat exchange between exhaustion gases (8-23) and feed water, that is part of the purge (33-34) from low pressure drum (6), producing high pressure steam (1-34).

The discharge of exhaustion gases (23) from Heat Recovery Steam Generator—HRSG (10) flows, then, to the pre-heater (5).

From the pre-heater (5), the cooled exhaustion gases (24) are succioned by ejector (7), joining the driving steam stream from low pressure drum (32), forming a exhaustion gases stream (25), innovation 3.

The exhaustion gases stream (25) is bubbled on the bottom of condenser (15), condensing most of water steam, which level is maintained by an overflow (35). After flows through the liquid, the incondensable part of exhaustion gases is released to atmosphere (26), after being washed in the condenser (15), innovation 4.

Yet in FIG. 1, water in condenser (15) is drained from bottom (28) and pumped to radiator (16) by circulation pump (14), where heat is lost and return to the top of condenser (15) as a “spray”.

The condensate pump (13), that is connected to the outlet of circulation pump (14), pumps the liquid (29) through the pre-heater (5), where it receives heat, and flows (30) to engine cooling system (4), feeding (31) the low pressure drum (6) with biphasic flux. This drum provides saturated steam, the driving steam of ejector, innovation 3, and the condensate that feeds the injection of innovation 2 and the feed water pump (12).

The feed water pump (12) feeds the Heat Recovery Steam Generator—HRSG (10) and the high pressure drum (1) with superheated steam.

Closing the cycle, this steam is injected inside the combustion chamber (20) in the engine block 93), joining the air and the fuel in the end of compression (C) stroke, that is represented by flux (2) in FIG. 1, innovation 1.

The table 1 shows the simulated cases according to mass and energy balance calculations, which results ground the use of invention.

TABLE 1
Calculated cases

| | |
|---|---|
| A | Reference Otto cycle gasoline engine described below |
| B | Combined cycle engine - prototype (modified reference |
| | engine) |
| O | Combined cycle engine - optimized (modified reference |
| | engine) |

The mechanical properties of a reference Otto cycle engine (A), summarized in table 2, were also used to the prototype of combined cycle engine (B) and to optimized engine (O) (except compression rate).

TABLE 2
Properties os the engines

| 2.1 | Total piston displacement | 1,795.6 | cm³ |
|---|---|---|---|
| 2.2 | Amount of cylinders | 4 in line | |
| 2.3 | Compression rate | 10.5:1 | |
| 2.4 | Piston travel | 88.2 | mm |
| 2.5 | Piston diameter | 80.5 | mm |

| | | |
|---|---|---|
| 2.6 | Amount of cylinder per valves | 2 |

In case of reference Otto cycle engine (A), it was set and determined the thermal yield in the engine, the efficiency of combustion gases expansion process, the heat transfer factors, the flow rate capacity of discharge valve and the reference temperature to avoid autoignition (detonation).

The operational data measured used were:

TABLE 3
Operational data of Reference Otto cycle engine (A)

| 3.1 | Rotation | 3.600 | RPM |
|---|---|---|---|
| 3.2 | Net power measured | 53.00 | kW |
| 3.3 | Specific gasoline consumption | 283.91 | g/kW |
| 3.4 | Air-Fuel ratio | 13.6 | [g/g] |
| 3.5 | Pressure in intake manifold | 0.915 | bar abs |
| 3.6 | Temperature in intake manifold | 25.3° | C. |
| 3.7 | Pressute in discharge manifold | 1.157 | bar abs |
| 3.8 | Temperature in exhaustion gas in | 907° | C. |
| | catalyst | | |
| 3.9 | Step | 20.7° | |
| 3.10 | Temperature in cooling water | 92.3° | C. |

It was estimated the following parameters to reference Otto cycle engine (A):

TABLE 4
Estimated data (to be confirmed experimentally)

| 4.1 | Drop of temperature in cylinders dicharge - | 10° | C. |
|---|---|---|---|
| | manifold | | |
| 4.2 | Comsumption of engine components (pumps, | 2.12 | kW |
| | fans, valve command, abrasion, etc . . .) | | |
| 4.3 | Combustion efficiency | 99.5% | |
| 4.4 | Pressure at top dead center (TDC) - end of | 1.036 | bar abs |
| | exhaustion (average between the pressures | | |
| | at intake and outlet manifolds). | | |
| 4.5 | Pressure at botom dead center (BDC) - end | 0.967 | bar abs |
| | of intake (RAM effect proportional to | | |
| | square of rotation) | | |

| | | |
|---|---|---|
| 4.6 | Composition of residual gas at TDC - end | 10% |
| | of exhaustion - combustion air/ | |
| | (combustion air + combustion gas) | |

The measurements were taken in the following environmental conditions:

TABLE 5
Environmental conditions

| | | | |
|---|---|---|---|
| 5.1 | Atmospheric pressure | 0.95377 | bar abs |
| 5.2 | Environmental temperature | 17.2° | C. |

| | | |
|---|---|---|
| 5.3 | Relative humidity | 63.3% |

The results of mass and energy balance calculation in the reference combustion engine are presented summarized in the table below and in FIGS. 2 and 5.

For engine performance shown in tables 2 an 3, it was determined the following parameters:

TABLE 6
Results of mass and energy balance in the reference engine

| 6.1 | Combustion/expansion efficiency | 95.4% | |
|---|---|---|---|
| 6.2 | Overall thermal efficiency | 29.12% | |
| 6.3 | Combustion thermal power | 182.0 | kW |
| 6.4 | Gasoline consumption | 17.9 | l/h |
| 6.5 | Mechanical power generated in | 103.6 | kW |
| | expansion | | |
| 6.6 | Mechanical power consumed in | 37.5 | kW |
| | compression | | |
| 6.7 | Mechanical power consumed in | 7.6 | kW |
| | exhaustion | | |
| 6.8 | Mechanical power consumed in | 3.3 | kW |
| | intake | | |
| 6.9 | Thermal power dissipated in | 54.7 | kW |
| | radiator | | |
| 6.10 | Thermal power dischage by muffler | 52.8 | kW |
| 6.11 | Reference temperature to the | 564.3° | C. |
| | autoignition (detonation) | | |

The massa and energy balances in combined cycle engine prototype (B) were made assuming data in conservative design in order to obtain experimental data for an advanced and optimized design in a combined cycle engine (O). The project data assumed were:

TABLE 7
Project data in combined cycle engine prototype (B)

| 7.1 | Compression rate | 14:1 | |
|---|---|---|---|
| 7.2 | Composition of residual gas at TDC - end of | 90% | |
| | exhaustion - combustion air/(combustion | | |
| | air + combustion gas) | | |
| 7.3 | Temperature drop between the cylinders | 10° | C. |
| | discharge and teh Heat Recovery Steam | | |
| | Generator—HRSG | | |
| 7.4 | Minimum temperature difference in HRSG | 30° | C. |
| | (“pintch point”) | | |
| 7.5 | Pressute in discharge manifold | 0.88 | bar abs |
| 7.6 | Pressure drop in HRSG | 0.1 | bar abs |
| 7.7 | Pressure at high pressure steam (VA) | 225 | bar abs |

| | | |
|---|---|---|
| 7.8 | Efficiency of high pressure steam expansion | 60% |
| 7.9 | Efficiency of high pressure steam expansion | 60% |
| 7.10 | Pumps efficiency | 50% |

In table below, it is summarized the main massa and energy balance results in the combined cycle engine prototype (B). In parenthesis, the difference for a reference Otto cycle engine (A):

TABLE 8
Results of mass and energy balance in the
combined cycle engine prototype (B).

| 8.1 | Net power | 82.4 | kW (55.5%) |
|---|---|---|---|
| 8.2 | Overall thermal efficiency | 42.9% (47.4%) | |
| 8.3 | Combustion thermal power | 192.0 | kW (5.5%) |
| 8.4 | Gasoline consumption | 18.9 | l/h (5.5%) |
| 8.5 | Temperature of engine exhaustion | 654° | C. |
| | gases (HRSG inlet) | | |
| 8.6 | High pressure steam flow rate | 0.0219 | kg/s |
| 8.7 | Temperature of high pressure steam | 624° | C. |
| 8.8 | Low pressure steam flow rate | 0.0142 | kg/s |
| 8.9 | Temperature of condensate (low | 168° | C. |
| | pressure steam) | | |
| 8.9 | Pressure of condensate (low | 7.5 | bar abs |
| | pressure steam) | | |
| 8.10 | Flow rate of low pressure | 0.00332 | kg/s |
| | condensate injection | | |
| 8.11 | Power of driving steam (VB) | 3.0 | kW |
| 8.12 | Thermal load in condenser | 97 | kW |
| | (radiator) | | |
| 8.13 | Power of feed water pump | 1.1 | kW |

The volumetric capacity, i.e., the combustion capacity of combined cycle engine prototype (B) is 5.5% greater than Otto cycle engine (A) as a result of the following factors:

TABLE 9
Parameters that influence the engine volumetric capacity

| In favour of combined cycle | In favour of Otto cycle |
|---|---|
| engine prototype (B) | engine (A) |
| Lower temperature in the end | Less steam in the end of |
| of intake | intake |
| Air in residual gas (assumed | Greater volume in combustion |
| 90% versus 10%) to be adjusted | chamber (20) (lower |
| experimentally | compression rate) |

In calculations, it were not considered RAM effet variation, that is the inertia of combustion air during intake—internal pressure in cylinders in the end of intake higher than the pressure of intake manifold. Besides considering the same rotation in both of the cases, this effect should be higher in combined cycle engine prototype (B) due to condensate injection during the opening of intake valve and to the lower pressure in discharge manifold. In theoretical calculations, this effect was neglected. It should be verified experimentally.

In the case of optimized combined cycle engine (O), the mass and energy balances were made to estimate the limit of efficiency in combined cycle engine. The following data in the project of optimized engine (O) were used:

TABLE 10
Project data of optimized combined cycle engine (O)

| 10.1 | Compression rate | 25:1 | |
|---|---|---|---|
| 10.2 | Temperature drop between the cylinders | 1° | C. |
| | discharge and the Heat Recovery Steam | | |
| | Generator—HRSG | | |
| 10.3 | Minimum temperature difference in HRSG | 3° | C. |
| | (“pintch point”) - pressure drop 0.2bar | | |
| 10.4 | Pressure at high pressure steam (VA) | 400 | bar abs |

| | | |
|---|---|---|
| 10.5 | Efficiency of high pressure steam | 90% |
| | expansion | |
| 10.6 | Efficiency of low pressure steam | 90% |
| | expansion | |
| 10.7 | Pumps efficiency | 80% |

In table below, it is summarized the main mass and energy balances results in the optimized combined cycle engine (O). In parenthesis, the difference for a reference Otto cycle engine (A):

TABLE 11
Results of mass and energy balances in
the advanved combined cycle engine.

| 11.1 | Net power | 84.3 | kW (59%) |
|---|---|---|---|
| 11.2 | Overall thermal efficiency | 44.9% (54.3%) | |
| 11.3 | Combustion thermal power | 187.6 | kW (3.1%) |
| 11.4 | Gasoline consumption | 18.5 | l/h (3.1%) |
| 11.5 | Temperature of engine exhaustion | 558° | C. |
| | gases (HRSG inlet) | | |
| 11.6 | High pressure steam flow rate | 0.0185 | kg/s |
| 11.7 | Temperature of high pressure steam | 555° | C. |
| | (VA) | | |
| 11.8 | Low pressure steam flow rate | 0.0156 | kg/s |
| 11.9 | Temperature of condensate (low | 163° | C. |
| | pressure steam) | | |
| 11.10 | Temperature of condensate (low | 6.6 | bar abs |
| | pressure steam) | | |
| 11.11 | Flow rate of low pressure | 0.00553 | kg/s |
| | condensate injection | | |
| 11.12 | Power of driving steam (VB) | 4.6 | kW |
| 11.13 | Thermal load in condenser | 94.3 | kW |
| | (radiator) | | |
| 11.14 | Power of feed water pump | 1.0 | kW |

Simulations Results

In the FIGS. 2 to 7, the curves follows Otto or Diesel cycle, beginning from Intake (I). It goes to the right until the beginning of compression (C). Then, the power (P) and the exhaustion (E), until return to the beginning of intake (I).

The FIG. 2 shows the curves of gas pressure inside the combustion chamber (20) in bar abs as a function of crankshaft angle for each of the four strokes of a reference Otto cycle engine (A).

The opening of intake valve (80) happens just before the end of exhaustion (E), and still open during all intake (I) stroke and close (81) in the beginning of compression (C). The opening of intake valve (85) happens before the end of power (E), and still open during all the exhaustion (E) stroke, closing (86) in the beginning of intake (I). Thus, for a brief period, the two valves remain opened, between the opening of intake valve (8) and the closing of exhaustion valve (86).

In FIG. 3, there are shown the pressure curves inside the cylinder of a reference Otto cycle engine (A) and those of prototype of combined cycle engine (B) during the four strokes.

Using the ejector (7), innovation 3, the pressure in discharge manifold is lower than intake manifold pressure, that helps the flow of exhaustion gases. In conventional engine, the discharge pressure is higher than intake pressure demanding greater piston work to pump the exhaustion gases. Therefore, as shown in FIG. 3, the internal pressure in the cylinder at the beginning of intake (5) of prototype of combined cycle engine (B) is lower than that in a reference Otto cycle engine (A).

In the end of intake (51), the pressures are the same, as it was assumed the same RAM effect to both of the engines (see explanation of table 9). The final compression pressure (52) in a prototype of combined cycle engine (B) is higher than that in a reference Otto cycle engine (A) due to higher compression rate (from 14:1 to 10.5:1).

Besides lower internal temperature inside the cylinders of prototype of combined cycle engine (B) during the combustion (see FIG. 7), the internal pressure is higher than that in a reference Otto cycle engine (A), caused by greater compression rate and, mainly, by high pressure steam injection, preferably above critical pressure, in the end of compression until the beginning of combustion, innovation 1. In the same curves, from range 140 to 150 degrees, it is noted the effect of opening of discharge valve (54), increasing the pressure drop. In this ending of power (P) stroke, happens the critical flow and the discharge flow depends only on the conditions upstream the discharge valve.

In exhaustion (E) pressure curves, it is noted again the effect of lower pressure in discharge manifold (8) of prototype of combined cycle engine (B), when the flow throughout the valve is no longer critical and the discharge flowrate is proportional to pressure difference. The internal pressure of prototype of combined cycle engine (B) decreases faster than reference Otto cycle engine (A).

In FIG. 4, there are shown the pressure curves inside the cylinder of a reference Otto cycle engine (A), the curves of prototype of combined cycle engine (B), and those of optimized combined cycle engine (0) during the four strokes. The compression rate in optimized engine (0) is higher than that in a prototype of combined cycle engine (B), and consequently, the pressure at the end of compression is higher (55).

The FIG. 5 shows the curves of internal temperature inside the cylinders of reference Otto cycle engine (A), in Centigrads degrees, as a as a function of crankshaft angle for the four strokes (I, C, P, and E).

In FIG. 6, there are shown the internal temperatures curves inside the cylinders of a reference Otto cycle engine (A) and those in the prototype of combined cycle engine (B) during the four strokes (I, C, P, and E).

Due to the condensate injection of low pressure drum purge in the end of exhaustion (E) and in the beginning of intake (I), inovation 2, the gases temperature in the beginning of intake (56) in a prototype of combined cycle engine (B) is much lower than that in a reference Otto cycle engine (A).

Part of injected condensate evaporates due to lower pressure inside cylinders in relation to that in the drum (6) pushing the combustion gas from the cylinder. The other part of saturated condensate that is injected remains in liquid state as droplets that evaporates only in air intake keeping the relative humidity close to saturation. In this moment (56), the combustion chamber is occupied with saturated steam, small amount of residual combustion gas and flashed condensate. Besides the high temperature in engine block (3), the evaporation of condensate keeps the temperature of air-fuel mixture low inside the cylinders during intake (I) period. The low temperature and the presence of less residual exhaustion gas in the end of intake (I) increase the volumetric capacity of combined cycle engine compared to reference Otto engine, thus, higher combustion capacity.

With the lower temperature in the end of intake and small part of flashed condensate remained, the compression rate of combined cycle engine can increase, without burning. In curves of compression (C) temperature in Figure, it can be noted the momento of ignition (58), when the gas temperature in combined cycle engine (B) and in reference Otto cycle engine (A) are the same, besides the compression rates (14:1 to 10.5:1).

In power (P), it can be noted the effect of condensate and high pressure steam injections. The internal temperature of combined cycle engine (B) is substantially lower than the one in reference Otto cycle engine (A), reducing accordingly the NOx formation.

In FIG. 7, there are shown the temperature curves inside the cylinder of reference Otto cycle engine (A), the curves of prototype of combined cycle engine (B), and those of optimized combined cycle engine (O) during the four strokes. With the steam generator more efficient, the production of high pressure steam pressure is proportionally higher in combined cycle engine optimized (O) then in prototype of combined cycle engine (B) and, consequently, the reduction of combustion temperature is higher. Besides the higher compression rate (25:1) in combined cycle engine optimized (O), the internal temperature in cylinders at combustion (P) is the same as in combined cycle engine optimized (O) and in reference Otto cycle engine (A).

1. (canceled)

2. (canceled)

3. (canceled)

4. (canceled)

5. (canceled)

6. (canceled)

7. (canceled)

8. A combined cycle combustion engine process comprising an Otto cycle or Diesel cycle combustion engine attached to an energy recovery system in Rankine cycle characterized that
the exhaustion gases in discharge manifold (8) exchange heat with the purge (11-33) in low pressure drum (6) in Heat Recovery Steam Generator (10) to feed the high pressure steam drum (1) in form of high pressure superheated steam, preferably above critical pressure, the said high pressure steam is injected in cylinders (20) between the end of compression (C) and the beginning of power (P) stroke during Otto or Diesel cycle, that increases the pressure inside the combustion chamber (20);
the low pressure steam, generated with the heat of cooling system and with the residual heat in exhaustion gases and stored in low pressure drum (6), the steam is used as driving steam in a ejector (7) to reduce the pressure in gas manifold (8) line and, consequently, the intake gases pressure is higher than exhaustion pressure;
the low pressure saturated condensate, generated with the heat of cooling system and with the residual heat in exhaustion gases and stored in low pressure drum (6), the condensate is injected in the cylinder in the end of exhaustion (E
a water recovery and exhaustion gases treatment system is used, where the gas is bubbled inside the condenser (15) full of cooling liquid, the said liquid is a gas washer that retains the particulate material dragged by exhaustion gas, in the top part of condenser (15) there is a shower with cooled liquid form cooling system with radiator (16).

9. The combined cycle combustion engine process according to claim 1, characterized that it is used the heat recovery steam generator assembled downstream catalyst, using the heat generated in it to produce steam, lowering the heat reject to environment and increasing engine efficiency.

10. The process according to claim 1, characterized that the temperature inside combustion chamber is determined by the amount of high pressure steam and low pressure condensate injected in combustion chamber (20).

11. A process comprising the step of: using the combined cycle combustion engine as defined in claim 1 in one or more of motorcycles, cars, trucks, cargo vehicles, buses, agriculture machinery, power generator, propulsion of ships, boats, locomotives, and trains.
